(19) United States
(12) Patent Application Publication
(10) Pub. No.: US 2005/0123847 A1
(43) Pub. Date: Jun. 9, 2005

(54) Toners for electrophotographic imaging apparatus having anti-streaking and anti-filming properties

(76) Inventor: Sang-deok Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/991,441

(22) Filed: Nov. 19, 2004

(30) Foreign Application Priority Data
Dec. 6, 2003 (KR) 2003-88413

(51) Int. Cl. G03G 9/087

(52) U.S. Cl. 430/109.4

(57) ABSTRACT

A toner for an electrophotographic imaging apparatus is provided. The toner can stably maintain the charge quantity and charge distribution of the toner in a stable condition, prevent streaking due to the solidification of the toner at a high temperature and humidity, and prevent filming in a developing roller and a toner layer regulator. The toner includes a polyester binder resin having a trimesic acid residue.

### CROSS-REFERENCE TO RELATED APPLICATION

This application claims the benefit of Korean Patent Application No. 2003-88413, filed on Dec. 6, 2003, in the Korean Intellectual Property Office, the disclosure of which is incorporated by reference herein in its entirety.

### BACKGROUND OF THE INVENTION

1. Field of the Invention

The present invention relates to toners for electrophotographic imaging apparatus. More particularly, the invention relates to improved stable nonmagnetic toners for electrophotographic imaging apparatus. The stable toner maintains the charge quantity and the charge distribution, prevents streaking due to the solidification of the toner at high temperatures and humidity, and prevents filming on the developing roller and the toner layer regulator of the apparatus.

2. Description of the Related Art

FIG. 1 is a schematic view of a conventional electrophotographic imaging apparatus that utilizes a non-contact developing method and which operates as described below. A photoreceptor 1 is charged by a charging unit 6, and then an electrostatic latent image is formed in the photoreceptor 1 by exposing an image to light through a laser scanning unit (LSU) 9. A toner 4 is supplied to a developing roller 2 by a toner supply roller 3. The toner 4 supplied to the developing roller 2 is laminated to a uniform thickness by a toner layer regulator 5 and is simultaneously charged by vigorous friction. Then, the laminated toner is developed into the electrostatic latent image formed in the photoreceptor 1 by electrostatic force, and then the developed toner is transferred to a sheet of paper by a transfer roller (not shown) and fixed to a fixing unit (not shown). A cleaning blade 7 cleans any residual toner 8 that remains after the transferring of the photoreceptor image.

As described above, in the imaging method comprising charging, exposing to light, developing, transferring, and cleaning (repeated), imaging is accomplished by an electric field acting between the developing roller and the photoreceptor after regulating M/A (mg/cm²: the weight of the toner per unit area as measured on the developing roller after the toner is passed through the toner layer regulator) and Q/M (μC/g: the charge quantity per unit weight of the toner as measured on the developing roller after the toner is passed through the toner layer regulator) of the toner supplied to a developing region using the toner layer regulator. Developing is either a contact developing method or a non-contact developing method. In the contact developing method, a developer is transferred to the latent image by contacting the developing roller with a surface of the photoreceptor. In the non-contact developing method, since the developing roller and the surface of the photoreceptor are separated by a predetermined distance, the developer gets transferred because of an electric force produced due to a potential difference between a voltage applied to the developing roller and a latent image potential of the photoreceptor. The contact developing method wears down the photoreceptor and the developing roller. Meanwhile, the non-contact developing method results in good durability and a high resolution due to developing by electric force.

The developer in the electrophotographic imaging apparatus is generally a toner mixed with a carrier but can be a toner by itself when a carrier is not used. A non-magnetic developer moves without requiring a magnetic force to be present, by taking advantage of the fluidity of developer particles. A magnetic developer moves due to the magnetic force produced by mixing a developer with a magnetic material such as ferrite. The non-magnetic developer is inexpensive and can be used for color printing since it does not use a magnetic material.

Recently, a low temperature fixing characteristic is required of the toner to save energy and decrease the waiting period for printing. For this, a binder resin and a releasing agent having good fixing characteristics within a broad temperature range are used. In addition, the fluidity and the charge characteristic of the toner particles have been improved through spherical toner particles and an external additive of silica or TiO₂ in order to improve developing ability, durability, and transfer efficiency of the toner and in order to prevent fogging of a nonimaging portion.

Conventional toners cause overcharging at a low temperature and humidity and cause the fogging of a nonimaging portion and toner scattering due to a decrease in the charge quantity at high temperatures and humidity. In other words, conventional toners have very high fluctuations in the charge characteristic of the toner with respect to environmental changes. Furthermore, although conventional toners have a uniform charge quantity and charge distribution at the beginning of the printing, their charge quantities greatly decreases over time, and a decrease in the image density, fogging, and toner scattering result from a decrease in the charge quantity and a non-uniform charge distribution when printing for a long period of time.

To solve the above problems and to give a uniform charge characteristic to the toner, a laminated toner layer can be formed on the developing roller. However, when the toner layer is too thin, the toner deteriorates due to toner stress and the developing efficiency sharply decreases due to a sharp increase in the toner charge quantity, thereby causing a decrease in the image density. When the toner charge quantity is regulated to a low level in order to improve the decrease in the developing efficiency, contamination problems are caused due to an increase in fogging and toner scattering. Also, the toner charge quantity can be regulated by adding an external additive such as silica and TiO₂ to the toner in order to maintain the charge stability and the uniform charge distribution of the toner when conducting a printing operation for a long period of time. However, this method also has limitations in preventing the fogging and in improving the developing ability at the end of the printing operation.

### SUMMARY OF THE INVENTION

The present invention provides an improved toner for an electrophotographic imaging apparatus. The toner is stable and maintains a charge quantity and a charge distribution, prevents streaking due to the solidification of the toner at high temperatures and humidity, and prevents filming on the developing roller and the toner layer regulator of the apparatus.

The present invention also provides an electrophotographic imaging apparatus employing the toner.

According to an aspect of the present invention, a toner is provided for an electrophotographic imaging apparatus, where the toner includes a binder resin, a colorant, a releasing agent, and a charge controlling agent (CCA), wherein the binder resin is a polyester resin including a trimesic acid residue.

The toner for an electrophotographic imaging apparatus according to an aspect of the present invention maintains the charge quantity and charge distribution in a stable condition, prevents streaking due to the solidification of the toner at high temperatures and humidity, and prevents filming on the developing roller and the toner layer regulator of the apparatus.

### BRIEF DESCRIPTION OF THE DRAWINGS

The above and other features and advantages of the present invention will become more apparent by describing in detail exemplary embodiments thereof with reference to the attached drawing in which:

FIG. 1 is a schematic view of a conventional electrophotographic imaging apparatus that utilizes a non-contact developing method.

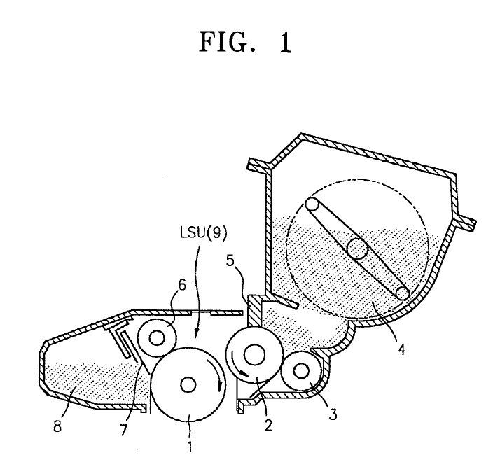

### DETAILED DESCRIPTION OF THE INVENTION

A toner for an electrophotographic imaging apparatus, such as a laser printer, a fax machine, or a photocopier, according to an embodiment of the present invention includes a binder resin, a colorant, a releasing agent, and a charge controlling agent. The binder resin is preferably a polyester resin including a trimesic acid residue.

In general, examples of the binder resin used in toners for an electrophotographic imaging apparatus include polystyrene-co-butadiene, polystyrene-co-acrylonitrile, modified acrylic polymer, polyvinyl acetate, styrene-alkyd resins, soya-alkyl resins, polyvinylchloride, polyvinylidene chloride, polyacrylonitrile, polycarbonates, polyacrylic acid, polyacrylates, polymethacrylates, styrene polymers, polyvinyl butyral, alkyd resins, polyamides, polyurethanes, polyesters, polysulfons, polyethers, polyketones, phenoxy resins, epoxy resins, silicone resins, polysiloxanes, poly(hydroxyether) resins, polyhydroxystyrene resins, Novolak, poly(phenylglycidylether)-co-dicyclopentadiene, a copolymer of the monomers used in the foregoing polymers, and a combination thereof. Among these materials, polyester resins are appropriate to a color developer due to their good fixing property and transparency.

The binder resin in the toner according to an embodiment of the present invention is preferably a polyester resin formed by a reaction between a dicarboxylic acid and a diol component. In one embodiment, the polyester resin is produced from trimesic acid and a diol component.

In preferred embodiments of the invention, the binder is produced from a polybasic acid component and a polyol component where the polybasic acid component contains trimesic acid (1,3,5 benzene tricarboxylic acid). The concentration of the trimesic acid residue is about 5 to about 30% by weight based on the weight of the binder resin. In one embodiment, the binder resin is produced by reacting a polybasic carboxylic acid component and polyol component where the polybasic carboxylic acid is a mixture of at least one dibasic carboxylic acid and trimesic acid. In another embodiment, the polybasic carboxylic acid component consists essentially of trimesic acid. In still another embodiment, the polybasic carboxylic acid component consists essentially of a dicarboxylic acid and trimesic acid.

Dicarboxylic acids commonly used to prepare the binder resin are used as the dicarboxylic acid in the polybasic carboxylic acid component polyesterification reaction of the present invention. Examples of suitable dicarboxylic acids include, but are not limited to, aliphatic carboxylic acids such as malonic acid, succinic acid, adipic acid, and sebacinic acid; and aromatic carboxylic acids such as phthalic acid, isophthalic acid, and terephthalic acid. The concentration of the dicarboxylic acid is at a level commonly used in the art.

Also, diols commonly used to prepare the toner binder resin are used as the diol component in the present invention. Examples thereof include, but are not limited to, ethylene glycol, butylene glycol, bisphenyl-A, and derivatives thereof.

The acid value of the binder resin may be not more than 12 mgKOH/g. The toner tends to deposit on the blades of the apparatus when the acid value of the binder resin is higher than 12 mgKOH/g. The melting temperature (Tₘ) of the binder resin is typically 130-150° C. (FT condition weight: 20 kgf, Die: 1 mm, Inc. temperature: 6° C./min).

The molecular weight of the benzenetrimesic acid monomer may be 210.

The toner according to an embodiment of the present invention may further include a colorant. For a black toner, carbon black and aniline black may be used as the colorant, while for a color toner, carbon black is used as the black colorant and yellow, magenta, and cyan colorants are used as the color colorant.

Examples of the yellow colorant include a condensed nitrogen compound, an isoindolinone compound, an anthraquine compound, an azo metal complex, and an allyl imide compound. Specifically, C.I. pigment yellow 12, 13, 14, 17, 62, 74, 83, 93, 94, 95, 109, 110, 111, 128, 129, 147, and 168 may be used.

Examples of the magenta colorant include a condensed nitrogen compound, an antraquine compound, a quinacridone compound, a naphthol compound, a benzo imidazole compound, a thioindigo compound, or a pherylene compound. Specifically, C.I. pigment red 2, 3, 5, 6, 7, 23, 48:2, 48:3, 48:4, 57:1, 81:1, 144, 146, 166, 169, 177, 184, 185, 202, 206, 220, 221, and 254 may be used.

Examples of the cyan colorant include a copper phthalocyanine compound and derivatives thereof, and a anthraquine compound. Specifically, C.I. pigment blue 1, 7, 15, 15:1, 15:2, 15:3, 15:4, 60, 62, and 66 may be used.

These colorants may be used alone or in combination and are selected in consideration of the desired color, saturation, brightness, weatherproofing ability, and dispersibility in a toner.

Releasing agents known in the art may be used as the releasing agent for enhancing releasibility of the toner from the various components of the apparatus. Examples of suitable releasing agents include polyalkylene waxes including low molecular weight polypropylene and low molecular weight polyethylene, ester wax, carnauba wax, paraffin wax, higher fatty acid, and fatty acid amide. In addition, a higher fatty acid and a metal salt thereof may be added to the toner as needed in order to obtain a high quality image by protecting the photoreceptor and preventing the deterioration of the developing characteristic of the toner.

Examples of a negative CCA include organic metal complexes and chelate compounds, such as chromium-containing azo dyes or monoazo metal complexes; salicylic acid containing a metal, such as chromium, iron, and zinc; and organic metal complexes of aromatic hydroxycarboxylic acids and aromatic dicarboxylic acids. In addition, any negative CCA known in the art may be used. Examples of a positive CCA include nigrosine and modified products thereof, such as a fatty acid metal salt thereof, and onium salts including a quaternary ammonium salt, such as tributylbenzylammonium 1-hydroxy-4-naphtosulfonate and tetrabutylammonium tetrafluoroborate. The foregoing materials may be used alone or in combination. Also, the toner according to an embodiment of the present invention can further include other particles, for example, silica, titanium oxides, silicon carbides, aluminas, and other polymer beads as the external additive.

In particular, when silica is used as the external additive, the fluidity, transferability, and durability of the toner can be improved. At least one type of silica may be used and at least two types of silica with different particle diameters may be used. For the two types of silica, silica with a larger particle diameter is referred to as a first silica and silica with a smaller particle diameter is referred to as a second silica. The first silica has a relatively large primary particle diameter in the range of 30-200 nm, and the second silica has a small primary particle diameter in the range of 5-20 nm. In embodiments where silica particles with different particle diameters are used, the first silica mainly acts as spacer particles to prevent the deterioration of the toner due to compacting, agglomeration and collapse of the spaces between adjacent particles and improves the transferability of the toner, while the second silica mainly provides the fluid characteristics of the toner. The first silica and the second silica, respectively, can each be used in an amount of 0.1-3.0 parts by weight based on 100 parts by weight of the toner. It is difficult to obtain the above described effect when the silica is included in amounts of less than 0.1 parts by weight. Also, the fixing property of the toner decreases, and overcharging and poor cleaning are caused when the amount of silica is more than 3.0 parts by weight.

The toner according to an embodiment of the present invention may be prepared by polymerization as well as pulverization. To deposit the external additive on the toner particles, the toner particles and the external additive are compounded at a predetermined ratio and stirred in a stirring apparatus such as a Henschel mixer. Alternatively, both are stirred in a surface modifying apparatus, such as a Nara Hybridizer, and the external additive is fixed to the toner particles by burying at least a portion of the external additive in the surface of the toner particles.

An electrophotographic imaging apparatus employing the toner according to another embodiment of the present invention includes, but are not limited to, conventional electrophotographic imaging apparatus such as printers including a laser beam or LED print head type printer, fax machines, photocopiers, and multifunction devices.

The present invention will now be described in greater detail with reference to the following examples. The following examples are for illustrative purposes only, and are not intended to limit the scope of the invention.

### EXAMPLE

Manufacturing of a Toner According to the Present Invention

60% by weight of bisphenyl-A as a diol component, 15% by weight of phthalic anhydride as a dicarboxylic acid component, 15% by weight of trimesic acid monomer as a tricarboxylic acid component, 5% by weight of carbon black available from Mitsubishi Chemical Co. Ltd. as a colorant, 3% by weight of a charge controlling agent available from Orient Chemical Co. Ltd., and 2% by weight of a low molecular weight polypropylene wax available from Sanyo Chemical Industrial Co. Ltd. were premixed using a Henschel type mixer. Then, the mixture was placed in a twin-screw extruder to produce a molten mixture. The molten mixture was extruded at 130° C. and solidified by cooling to produce the polyester binder component. Then, an untreated toner with an average particle diameter of about 8 μm was obtained using a pulverization classifier, and 1.0% by weight of a first silica with a primary particle diameter of 30-50 nm (−300 to −600 μC/g) and 1.0% by weight of a second silica with a primary particle diameter of 7-16 nm (−400 to −800 μC/g) were added thereto. As a result, the toner according to the present invention was obtained.

### COMPARATIVE EXAMPLE

A toner was prepared in the same manner as in the Example, except that a trimesic acid monomer was not added.

Image Evaluating Test

An image evaluation was performed on toners prepared in the Example and the Comparative Example using a 20 ppm LBP printer. Image density, filming, dot reproducibility (rate of producing a partial image density difference), and streaking of the image were measured, and the performance of the toners was evaluated. At this time, the image density was obtained by measuring the density of a solid pattern on a sheet of paper using a densitometer (SpectroEye, GretagMacbeth Co., Ltd.), while filming, dot reproducibility, and streaking were evaluated by visual inspection. A developing apparatus was operated under the following conditions.
Surface potential (V₀): −700 V
Latent image potential (V_{L}): −100 V
Voltage applied to developing roller:
   Vₚ₋ₚ=1.8 KV, Frequency: 2.0 kHz
   V_{dc}=−500 V, Efficiency ratio: 5% (square wave)
Developing gap: 150-400 developing roller
(1) Aluminium roller
   Roughness: Rz=1-2.5 (after plating with nickel)
(2) Rubber roller (NBR elastic rubber roller)
   Resistance: 1×10⁵−5×10⁶ Ω
   Hardness: 50
   Toner: Charge quantity (q/m)=−5 to −30 μC/g (on the developing roller after passing through the toner layer regulator)
   Amount of toner per area: 0.3-1.0 mg/cm²

The image evaluating results according to the number of sheets of printing paper for toners according to the Example and the Comparative Example, respectively, are shown in Tables 1 and 2 below.

TABLE 1
Toner manufactured according to the Example

Number of sheets of printing paper

| | 0 | 1,000 | 2,000 | 3,000 | 4,000 | 5,000 |
|---|---|---|---|---|---|---|
| Image density | ∘ | ∘ | ∘ | ∘ | ∘ | ∘ |
| Filming | ∘ | ∘ | ∘ | ∘ | ∘ | ∘ |
| Dot | ∘ | ∘ | ∘ | ∘ | Δ | Δ |
| reproducibility | | | | | | |
| Streaking | ∘ | ∘ | ∘ | ∘ | ∘ | ∘ |

TABLE 2
Toner manufactured according to the Comparative Example

Number of sheets of printing paper

| | 0 | 1,000 | 2,000 | 3,000 | 4,000 | 5,000 |
|---|---|---|---|---|---|---|
| Image density | ◯ | ◯ | X | X | X | X |
| Filming | ◯ | X | X | X | X | X |
| Dot | ◯ | ◯ | ◯ | Δ | Δ | X |
| reproducibility | | | | | | |
| Streaking | ◯ | X | X | X | X | X |

Image Density:
Less than 1.1=X, 1.1˜1.3=Δ, more than 1.3=o

Filming, Dot Reproducibility, and Streaking:
Not found by the naked eye=o
Found by the naked eye but not serious=Δ
Found by the naked eye and serious=X

As described above, the toner for an electrophotographic imaging apparatus according to an embodiment of the present invention can maintain the charge quantity and charge distribution of the toner in a stable condition, prevent streaking due to the solidification of the toner at a high temperature and humidity, and prevent filming in a developing roller and a toner layer regulator.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A toner for an electrophotographic imaging apparatus, comprising a binder resin, a colorant, a releasing agent, and a charge controlling agent, wherein the binder resin is a polyester resin comprising a trimesic acid residue.

2. The toner of claim 1, wherein the concentration of the trimesic acid residue is 5-30% by weight based on the weight of the binder resin.

3. The toner of claim 1, wherein the binder resin is produced from an aliphatic dicarboxylic acid or an aromatic dicarboxylic acid.

4. The toner of claim 3, wherein said dicarboxylic acid is selected from the group consisting of malonic acid, succinic acid, adipic acid, and sebacinic acid.

5. The toner of claim 3, wherein said aromatic dicarboxylic acid is selected from the group consisting of phthalic acid, isophthalic acid, and terephthalic acid.

6. The toner of claim 1, wherein the binder resin has an acid value of not more than 12 mgKOH/g.

7. The toner of claim 1, wherein the binder resin has a melting temperature (Tₘ) of 130-150° C.

8. The toner of claim 1, wherein said polyester resin is obtained from a polybasic carboxylic acid component and a polyol, where said polybasic carboxylic acid component comprises trimesic acid.

9. The toner of claim 8, wherein said polybasic carboxylic component comprises a mixture of at least one dicarboxylic acid and trimesic acid.

10. The toner of claim 1, wherein said polyester resin is produced from a polybasic carboxylic acid monomer component and a polyol, wherein said polybasic carboxylic acid consists essentially of trimesic acid.

11. The toner of claim 1, wherein said polyester resin is produced from a polybasic carboxylic acid monomer component and a polyol, and wherein said polybasic carboxylic acid component consists essentially of a dicarboxylic acid and trimesic acid.

12. An electrophotographic imaging apparatus employing a toner of claim 1.
